(19) United States
(12) Patent Application Publication
(10) Pub. No.: US 2011/0191774 A1
(43) Pub. Date: Aug. 4, 2011

(54) NOC-CENTRIC SYSTEM EXPLORATION PLATFORM AND PARALLEL APPLICATION COMMUNICATION MECHANISM DESCRIPTION FORMAT USED BY THE SAME

(76) Inventors: Yar-Sun HSU, Hsinchu City (TW); Chi-Fu Chang, Taipei City (TW)

(21) Appl. No.: 12/697,697

(22) Filed: Feb. 1, 2010

(51) Int. Cl. G06F 17/50; G06F 9/46

(52) U.S. Cl. 718/100; 703/14

(57) ABSTRACT

Network-on-Chip (NoC) is to solve the performance bottleneck of communication in System-on-Chip, and the performance of the NoC significantly depends on the application traffic. The present invention establishes a system framework across multiple layers, and defines the interface function behaviors and the traffic patterns of layers. The present invention provides an application modeling in which the task-graph of parallel applications is described in a text method, called Parallel Application Communication Mechanism Description Format. The present invention further provides a system level NoC simulation framework, called NoC-centric System Exploration Platform, which defines the service spaces of layers in order to separate the traffic patterns and enable the independent designs of layers. Accordingly, the present invention can simulate a new design without modifying the framework of simulator or interface designs. Therefore, the present invention increases the design spaces of NoC simulators, and provides a modeling to evaluate the performance of NoC.

### FIELD OF THE INVENTION

The present invention relates to a SoC, particularly to a NoC-centric system exploration platform, which partitions a SoC design space into multiple layers having independent simulation models, and which uses text to describe a task graph of a parallel application.

### BACKGROUND OF THE INVENTION

The complexity of SoC (System-on-Chip) is increasing with the advance of VLSI. Because of the increasing number of multi-core processors, IP units, controllers, etc., the performance bottleneck has transferred from the computation circuits to the communication circuits, and the communication bottleneck becomes more serious. Thus, the communication circuit has become a key point in the design of a SoC.

The SoC design was originally computation-oriented, but it now turns to be communication-oriented. The Network-on-Chip (NoC) is a popular solution to the communication bottleneck. NoC can solve many problems frequently occurring in the current mainstream bus-based architectures, such as the problems of low scalability and low throughput. Nevertheless, NoC requires more network resources, such as buffers and switches, and involves the design of complicated and power-consuming circuits, such as routing units. Therefore, it is very important to undertake design exploration and system simulation before NoC is physically constructed.

FIG. 1 shows a conventional NoC simulation environment and flow, wherein the application modeling block 11 describes the traffic pattern. The NoC design block 12 describes the components, computation nodes, adaptors, etc., of a NoC. Further, the message characteristic block 13 describes the bus transaction, packet format, flow control unit, etc. The blocks 11, 12, 13 are used to be inputs of a NoC simulator 14, and the NoC simulator 14 outputs a simulation report 15 after the simulation is completed. However, the conventional simulation environment shown in FIG. 1 lacks a unified standard to describe the inputs of the application modeling block 11, NoC design block 12, and message characteristic block 13. Accordingly, one block needs a re-design to meet another NoC design, and the original blocks are hard to reuse. In other words, the design flexibility is reduced and the exploration space is also restricted.

The CoWare Convergence SC of the CoWare Company and the SoC Designer of the ARM Company had respectively proposed complete frameworks of the modeling of processing elements, IP units, and buses. However, the abovementioned frameworks adopt cycle-accurate hardware modeling and instruction-accurate software modeling, and thus have to spend much time simulating a complicated NoC. Further, the conventional techniques spend much effort on using executable codes to construct a new application to be used as an input and describing a new NoC under the bus favored interface. In order to solve the abovementioned problems, Xu et al. had proposed a computation-communication network model to construct the application traffic pattern mentioned in the IEEE paper of “A Methodology for Design, Modeling, and Analysis of Networks-on-Chip”, Circuits and Systems, 2005, ISCAS 2005. However, such a technology divides the simulation environment into many steps, each using different simulation tools and evaluation standards. Further, there is information loss between different steps. Therefore, the technology cannot achieve complete information of the system.

Besides, Kangas et al. used UML (Universal Modeling Language) to input both applications and modules based on task graphs in the paper of “UML-Based Multiprocessor SoC Design Framework”, ACM transaction on Embedded Computing Systems (TECS), 2006, Vol. 5, 2. However, the environment provided cannot directly apply the simulation models constructed from the SystemC language which is one of the most-used languages in hardware-software simulation designs.

### SUMMARY OF THE INVENTION

One objective of the present invention is to provide a system-level design framework which is not a complete NoC simulator. Instead, it simplifies some non-critical details of NoC and achieves a higher simulation speed in a NoC-centric system design simulation.

Another objective of the present invention is to provide a NoC-centric system exploration platform (Nocsep), which simplifies the system designs and construction processes, customizes the designs, and exempts users from niggling details of system designs, and which can explore the NoC design spaces in advance before software and hardware specifications have been settled.

Yet another objective of the present invention is to provide a Nocsep, whose models and system frameworks are independent of programming languages, whereby increasing the application flexibility of the simulation environment and expanding the exploration space of a NoC design.

Still another objective of the present invention is to provide a method to define applications, wherein PACMDF (Parallel Application Communication Mechanism Description Format)—a task-graph-based application modeling is used to generate traffic patterns similar to those generated by an instruction simulator, whereby avoiding the complexity of an accurate instruction and reducing the burden of application modeling.

A further objective of the present invention is to provide a system framework, which can evaluate efficiency when the system is being designed, and which does not adopt a RTL (Register Transfer Level) or cycle-accurate design but can adopt a cycle approximate event driven design, and which adopts a full-parameterized latency model to quantitatively evaluate the contribution of each design decision to the entire system.

In a NoC design, it needs to carefully consider various design trade-offs and to select the most efficient one. The designers should not apply all possible network designs to a chip because a NoC has fewer resources which can be used than a conventional network environment. A simulation can be used to evaluate how each part of the communication mechanism design contributes to the entire “NoC-centric system” (or “NoC system”) and then find out the design of the best cost-performance can be selected.

The simulation framework of the present invention is not to perform the final simulation after the design is completed. Instead, it verifies and modifies a NoC design during the design process. The present invention can simultaneously combine and verify different network levels and different granularities of software/hardware description to re-design the software and hardware of a NoC system, and then find out the best design according to the traffic patterns generated by real applications.

### BRIEF DESCRIPTION OF THE DRAWINGS

Below, the embodiments are described in detail in cooperation with the following drawings to make an easy understanding of the objectives, characteristics and efficacies of the present invention.

FIG. 1 is a diagram schematically showing a conventional NoC simulation environment;

FIG. 2 is a diagram schematically showing the simulation environment of a NoC according to the present invention (Nocsep);

FIG. 3 is a diagram schematically showing a NoC system layering according to the present invention;

FIG. 4A is a diagram schematically showing an application modeling according to the present invention;

FIG. 4B is a diagram showing an example of a task graphs;

FIG. 5 is a diagram schematically showing a node modeling according to the present invention; and

FIG. 6 is a diagram schematically showing an adaptor modeling according to the present invention.

### DETAILED DESCRIPTION OF THE PREFERRED EMBODIMENTS

The detailed description of the preferred embodiments is divided into the following parts, comprising:
1. NoC system exploration platform;
2. Performance evaluation;
3. System layering;
4. Application modeling;
5. PACMDF (Parallel Application Communication Mechanism Description Format); and
6. Middle layer modeling.

### NoC System Exploration Platform

In the present invention, the “system exploration” is defined to “evaluate the influence of a software or hardware design decision on the performance of the entire NoC system”. The platform of the present invention provides a system framework comprising all the components which influences a NoC system in various system layers. The platform is divided to layers, and the simulation models of layers are independent. Thus the exploration space of NoC system design is increased and easily modified.

In the specification, “NoC-centric system exploration platform” is abbreviated as “Nocsep”, and the terms of “NoC-centric system exploration platform” and “Nocsep” are used interchangeably. In the specification, also, “parallel application communication mechanism description format” is equivalent to “PACMDF”. In addition, the term of “modeling” of this present invention represents the uses of the “models” given by this invention. Nocsep does not aim to construct a more accurate model but to increase the flexibility of simulators and expand the exploration spaces of a NoC design. The term “exploration platform” distinguishes the present invention from the common NoC simulators. The present invention applies to the cases where the design spaces have not been settled down yet. The present invention explores possible design spaces of NoC via systematic, standardized simulations and a final design according to the performance evaluation of the implementations of various design spaces is selected. The term “system” in the title reflects that the present invention adopts the system-level methodology to simplify unnecessary simulation details in order to plan a feasible NoC design in advance.

The Nocsep of the present invention comprises three parts, comprising the model design, the system framework design and the simulation environment.

### 1. Model Design:

The present invention uses various models to form a NoC system. The model design is to design the software models, hardware models and communication message models required by a NoC-centric system. A multiple abstraction level modularization and network cross-layer issues are undertaken. The model design is further sorted into two types in Nocsep, comprising a NoC Service type and a NoC Service handler type.

a. NoC Service

The NoC Service type comprises a communication message model describing the communication contents for each NoC layer, the requests to the network resources for each NoC layer, and the information of the control and transaction of the requesting interfaces for each NoC layer. Herein, “Service” means all the information flowing intra-level and inter-level of one system. We use the word “Service” to refer to this meaning in this invention, such as the communication Service and the computation Service, both of which will be explained later.

b. NoC Service Handler

The NoC Service handler type comprises the NoC software model or NoC hardware model which is used to describe the methods for generating or handling a NoC Service.

### 2. System Framework Design

The system framework design constructs a simplified network cross-layer system framework from the system regulation to define the behaviors of various layer interfaces and the transmission methods of NoC communication contents. The purpose of the system framework design is to establish the traffic patterns from the topmost layer to the bottommost layer.

### 3. Simulation Environment

The simulation environment provides the simulation and performance evaluation according to the established NoC system based on the Nocsep models and the Nocsep system frameworks.

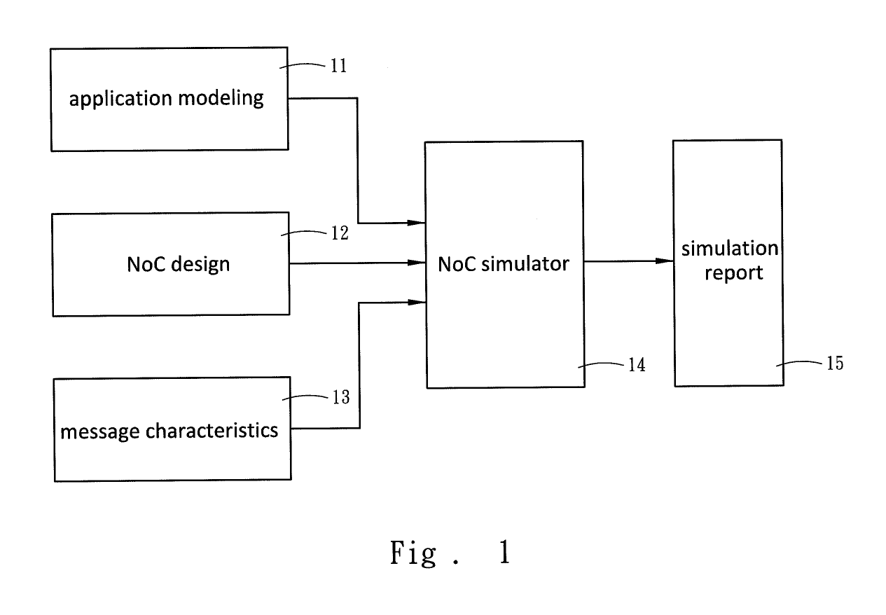

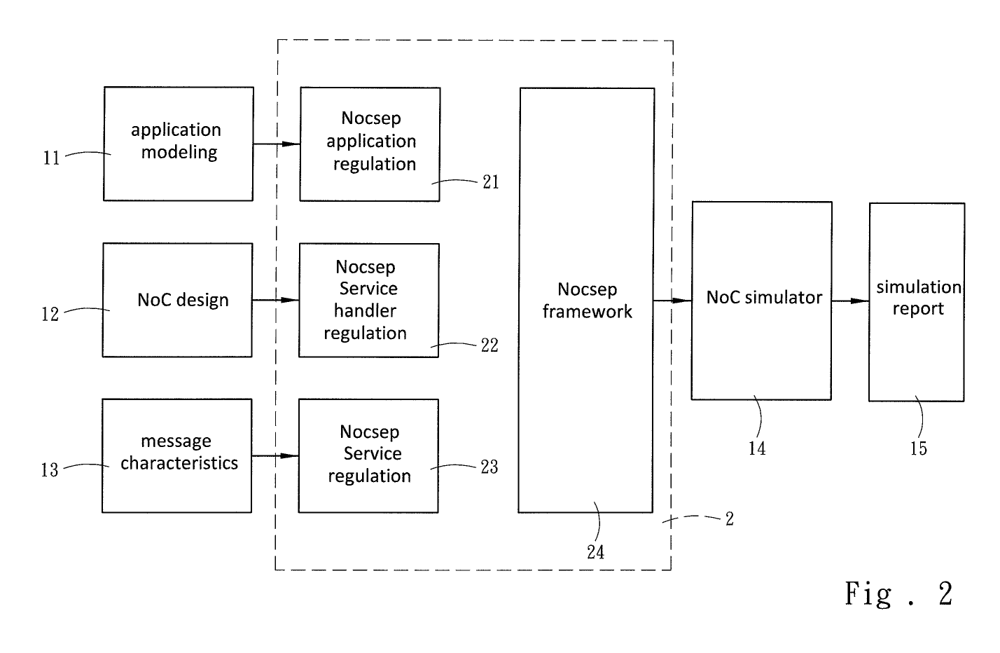

FIG. 2 shows the simulation environment of Nocsep. In addition to the conventional architecture shown in FIG. 1, the present invention further provides several universal regulations to describe the inputs, comprising a Nocsep application regulation 21, a Nocsep Service handler regulation 22 and a Nocsep Service regulation 23. Nocsep also constructs a framework 24 which are comprised of the regulations 21, 22, 23. Then, simulation is undertaken according to the unified input descriptions to obtain a simulation report 15.

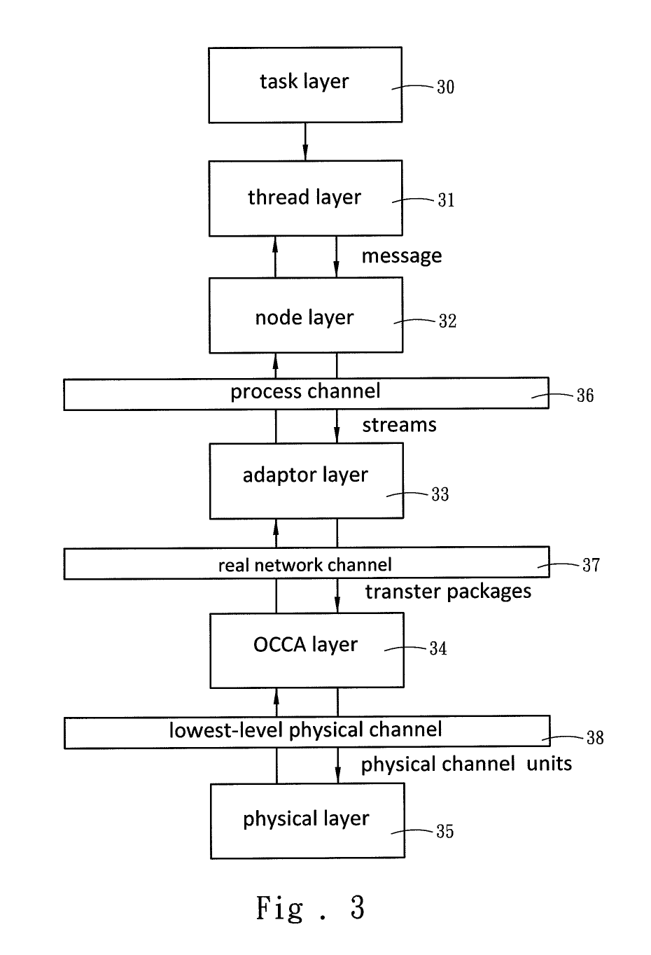

It will be discussed below that the Nocsep application regulation 21 uses a text method to describe the parallel application task graphs (shown in Table 4 and will be discussed in detail below) according to PACMDF of the present invention. The Nocsep Service handler regulation 22 corresponds to the concept of the object-oriented NoC design. The Nocsep Service regulation 23 corresponds to the message layering of the present invention (shown in FIG. 3 and will be discussed below).

The unified regulation description of Nocsep has the following advantages:
1. The scale of the simulation is not confined to a single component. It can be extended to the system level.
2. All NoC designs adopt the same framework and the same universal model to describe and thus the present invention has fair evaluations.
3. The simulation environment is independent of the designs, and separates the implementation of the simulators from the simulated targets; thus, a new component simulation can be performed without modifying the simulation environment.

### Performance Evaluation

The performance of a new NoC system has to be evaluated with the total execution time required by completing an application.

Most of the current NoC simulators evaluate the performance of a NoC design with the latency time and NoC behavior from the beginning of insertion to the end of the reception of a NoC traffic. The average flow rate, average communication latency and average contention rate of NoC are the indexes of the performance evaluation. The statistical features of an application are usually used as the application outputs of the NoC simulation. However, most of the application behaviors are non-random. The real application traffic pattern should consider the network resource allocation issues of inter- or intra-network layer, such as the task-mapping of application, the thread-grouping of operating-system, and the stream-packetization of network-interface, etc. The Nocsep of the present invention does not merely consider a single-layer design but also adds higher-level models of the network, such as the task layer, the thread layer, the node layer and the adaptor layer. The design covers the issues from the software layer to the OCCA (on-chip communication architecture) layer to enable the Nocsep software model to generate a traffic pattern to a NoC closer to a real case.

In the performance evaluation of a NoC, the Nocsep of the present invention adds the application operation time into the simulation latencies. Namely, the execution time of an application is evaluated via dividing the behaviors of an application into many Services, preserving the before and after relationships of the Services, and inputting the Services to a NoC system with multiple Service handlers. Thus, the present invention further combines the latencies of software and hardware to approach the real NoC system execution time on operations.

The above-stated “Service” means all the intra-layer and inter-layer information flows, such as hardware interface specifications, hardware control signals, software data, firmware tasks and missions, etc. Moreover, different network layers respectively use Services of different abstraction levels. The above-stated “Service handler” refers to the software or hardware which processes Services or transmits Services. The total execution time is the summation of multiple Service handling latencies. The Nocsep of the present invention also takes into consideration when latency overlap occurs.

The present invention divides the NoC design spaces into multiple design blocks and models them into many abstraction levels. The object-oriented network-on-chip modeling of the present invention uses the concept of “abstraction level” to balance the modeling accuracy and the construction overhead of a new NoC design. The so-called abstraction level is a block whose details of the hardware are contained in the component with higher level. If an abstraction level is examined microscopically, it is found that the characteristics of the hardware are well preserved inside. Therefore, the present invention can greatly reduce the details of the hardware construction and reduce the time used in simulation.

The present invention adopts a “cycle-approximation latency model” to evaluate the performance. The cycle-approximate latency model considers the behavior of each service handler as a plurality of sub-behaviors thereof Each sub-behavior may be divided into one or more sequential sub-actions each of which has parameterized latency. The sub-behaviors of one Service handler may proceed in parallel or sequentially. Some sub-behavior will not occur until a special event or a combination of special events has occurred. The latency of a Service handler also comprises the queue time waiting for other Services to be served. Thus, the latency has a tree-like structure, and the final latency of each node of this tree is the summation of the latency estimation of all its child nodes. Furthermore, the latency estimation of each node of the same tree-level might be dependent.

The cycle-approximation latency model is explained more in detail below. The total execution time of one application might be the time the commit of all parallel tasks occurs. The execution time of an application “task” is the summation of the time used in computation activities and communication activities, and it might be expressed by “total execution time”={computation activity, communication activity, computation activity}. The abovementioned communication activity may be resolved into many sub-activities, and it may be expressed by “communication time”={adaptor go-through time, switch go-through time, . . . , (more)}. The abovementioned switch go-through time may be resolved into further smaller components and expressed by “switch go-through time”={routing go-through time, resource allocation go-through time, . . . , (more)}. In the cycle-approximation latency model, the latencies are developed level by level to form a tree-like structure. The behavior latency time of the top-level is the summation of the latencies of the tree-like structure. The abovementioned latency items are only for exemplification of how the present invention estimates latency, but the present invention does not restrict its latency models.

### System Layering

In order to approach the real traffic pattern, the present invention only considers the NoC layers but also concerns higher-level modeling of the network, such as the task layer, the thread layer, the node layer and the adaptor layer, etc. As shown in FIG. 3, the present invention divides a NoC system into multiple layers, comprising a task layer 30, a thread layer 31, a node layer 32, an adaptor layer 33, an OCCA layer 34, and a physical layer 35 which are described below. Through combining these multiple layers, the present invention realizes a software-hardware co-simulation environment and simulates the NoC traffic with the different issues ranging from the highest application modeling to the lowest hardware implementation. However, the present invention does not limit the NoC system to be simulated to contain all these layers. A NoC system can comprise only the Task layer and the OCCA layer, for example. Besides, FIG. 3 shows only the “layering”, so in each layer can be one or many instances of that layer. For example, there are one or many tasks in the task layer. In the following paragraph, the “instance” of one layer represents the top-most simulation elements which compose that layer.

### Task Layer 30

The task layer 30 uses the task instances, (“tasks” in brief) to describe the features of applications. Each of the tasks corresponds to one Service. There are three types of Services: the computation Service, the communication Service and the event-triggered Service. The computation Service represents the computation request, workload and other computation-related information. The communication Service represents the communication request, workload and other communication-related information. The event-triggered Service represents the global input/output (I/O) behaviors. The features of the tasks comprise the outputs and the triggered-conditions of the Services. The task layer describes all the traffic contents entering/leaving the NoC system from some thread to another thread of the thread layer 31.

### Thread Layer 31

The thread layer 31 uses the thread instances (“threads” in brief) to describe the inter-task communication, the task grouping, the thread mapping and the parallelism design. Each thread is designed to encapsulate one or more tasks of the task layer 30. In the present invention, all the threads in this layer represent all traffic sources/destinations of the whole system.

### Node Layer 32

The node layer 32 uses node instances (“nodes” in brief) to concretely describe the thread arbitration, the thread scheduling, the multi-threading mechanism, etc. The node layer 32 contains one or many node instances. These nodes represent the real computing units handling the requests of the computation workloads and inter-threads workloads.

### Adaptor Layer 33

The adaptor layer 33 uses adaptor instances (“adaptors” in brief) to concretely describe the OCCA interface design and support various OCCA components, such as the circuit-switch network, packet-switch network and bus-like communication architecture, etc.

### OCCA Layer 34

All the objects and sub-objects which are used to construct one OCCA are arranged in this layer. The OCCA indicates that this layer supports not only NoC but also other communication architectures, such as bus. The present invention does not limit its OCCA target to any network topologies and communication structures.

### Physical Layer 35

The physical layer 35 provides the blocks of the register-transfer level or gate-level designs which are used as basic blocks to compose an OCCA instances.

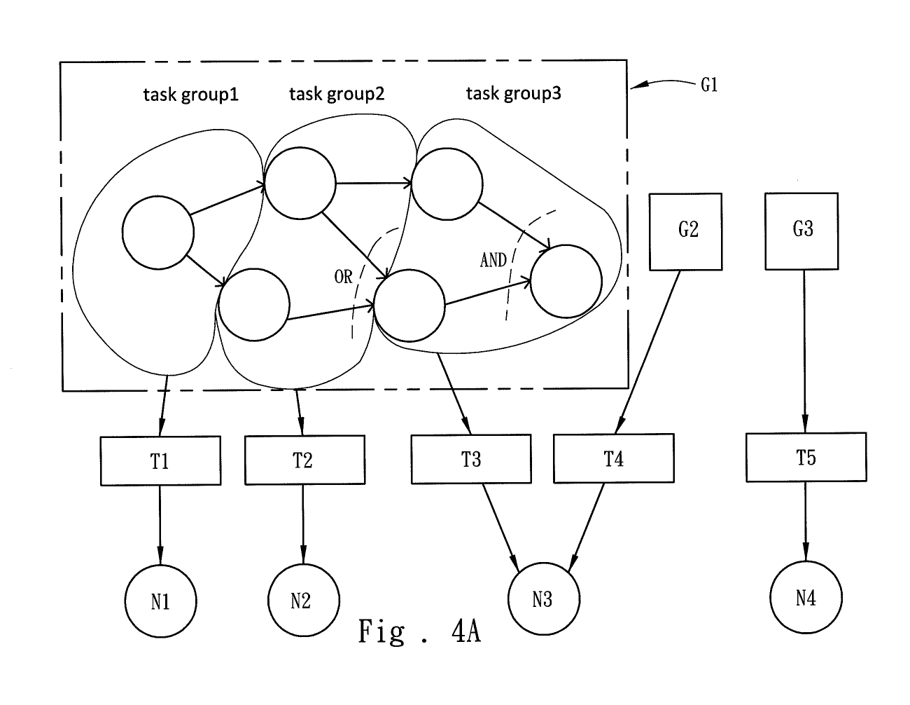

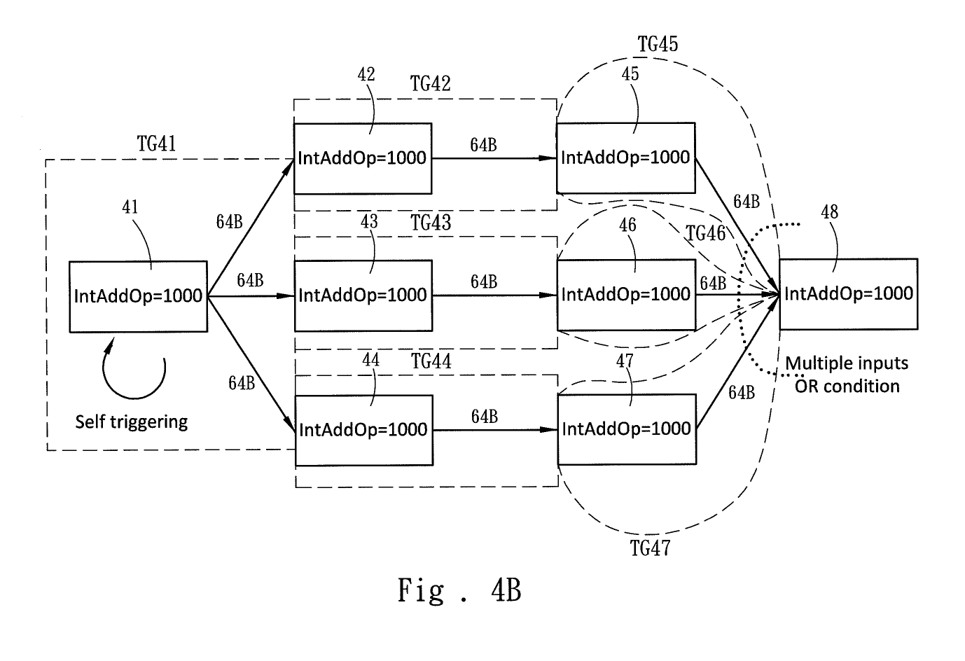

Refer to FIG. 3 and the arrows between the blocks represent traffic formats. In FIG. 3, the task layer 30 is the source of all traffic. Blocks 36, 37 and 38 are the “channels” used to separate two different layers in this present invention, and can be regarded as the hardware interfaces. Each of the channels is implemented by the components below it. When the user intends to simulate different hardware designs of the same layer, it can be done by making new designs to support the same interface without modifying the hardware models of other layers. The task layer 30 contained in the thread layer 31 generates the traffic in message format to the Node layer. More explanation will be given later in FIG. 4. In each layer of FIG. 3, the traffic is transformed into a different traffic format before passing through the channels 36, 37, 38. For example, each of the messages through the node layer 32 is transformed into one or multiple streams in the process channel 36. And, the streams pass through the process channel 36 and reach to the adaptor layer 33. The process channel 36 is a pseudo channel Nodes and it can be implemented as the Adaptors, OCCAs, and physical transmission channels (or “physical channels” in brief). Each of the streams through the adaptor layer 33 is transformed into transfer packages. The real network channel 37 is an I/O interface of the OCCA layer 34. The transfer packages passing through the OCCA layer 34 are transformed into physical channel units, and through the lowest-level physical channel 38, the physical channel units arrive at the physical layer 35. When the upper-level traffic is transformed into the lower-level traffic units, the lower-level traffic units jointly have all the contents of the source traffic format of the upper level.

The present invention divides a NoC design spaces into multiple network layers to establish the NoC regulations. Then, each network layer is further designed to construct different models with different abstraction levels, and then the sophisticated simulations can be accomplished. In the present invention, the goal of layering is to make the Service design spaces of each layer independent. Thus, each Service handler can only learn the information of its corresponding layer. The present invention does not limit its supported design issues of each layer to those above-mentioned example issues.

Based on the above-mentioned layering of a NoC system, there is also a layering of Service in the present invention, which adopts different data structures for different layers of a NoC system, so it can separate the design issues of the Service for different layers of one NoC system. The supported layers are not restricted to a fixed framework, such as a two-layer NoC system (with packet generators plus an OCCA layer) or six-layer NoC system (FIG. 3), the present invention is designed for easily adding or removing one layer to the simulated NoC system without changing the designs of other layers—including the Service designs and the Service handler designs in other layers. It is almost impossible for existent NoC simulators because their modeling of Service of different layers are shared or fixed in spec. As a result, the present invention reduces the overhead of coding and increases the simulation space.

Table 1 shows an example of the Service types and Service contents of each layer. The Service contents correspond to the above-mentioned example issues. The present invention does not limit the Service contents of each layer to the list given in Table 1. In the same way, the present invention does not limit the supported Service type to the list in Table 1.

TABLE 1

| Level | Service type | Service content |
|---|---|---|
| Task layer | task | 1. task type |
| | | 2. computation Service |
| | | content |
| | | 3. communication Service |
| | | content |
| Node layer | message | 1. task group ID |
| | | 2. all the contents of its |
| | | containing tasks |
| Adaptor | stream | 1. stream data size |
| layer | | 2. high-level protocol |
| | | information |
| | | 3. QoS constraints |
| | | 4. virtual channel ID |
| | | 5. all the contents of its |
| | | containing messages |
| OCCA layer | Packet, | 1. packetization |
| | Flow-control unit | 2. distribution allocating |
| | or BUS | routing information |
| | transaction unit | 3. flow unit priority |
| | | 4. IDs of preserving real |
| | | network resources (such as |
| | | pseudo channel) |
| | | 5. all the contents of its |
| | | containing streams |
| physical | physical channel | 1. time-division multiplexing |
| layer | unit, or | unit |
| | buffer item | 2. broken rate and correction |
| | | overhead |
| | | 3. detailed design in bit level |
| | | (e.g. the initial 5 bits for |
| | | routing, the middle 25 bits for |
| | | contents, the last 2 bit for |
| | | debugging) |
| | | 4. all the contents of its |
| | | containing Service package of |
| | | OCCA layer |

### Application Modeling

The Task layer, the Thread layer and the Node layer are all the parts of Nocsep application modeling. The external software and hardware information input to a NoC is contained in the Tasks, such as the topmost-level application, or the I/O elements of the system. The application-related designs (or software designs) are then described in Threads and Nodes. All the objects of these three layers determine the input/output of the application traffic of the whole system.

Refer to FIG. 4A for the application modeling of the present invention.

The traffic of threads might be a random traffic, an application-driven traffic and an even-triggered traffic. FIG. 4A shows an example of the traffic source of one NoC system. There are the generation of an application-driven traffic G1, a random traffic G2 and an event-triggered traffic G3. The random traffic G2 refers to software or hardware Services generated randomly from traffic statistical features. The event-triggered traffic G3 refers to event-triggered software or hardware Services generated according to a special event received by a thread, such as a data request. The application-driven traffic G1 is generated by an application, which can be described by PACMDF, and the details will be discussed below.

Several tasks may be combined to form a task group, and one task group has the same task group ID. In FIG. 4A, for example, the application-driven traffic G1 includes three task groups—task group 1, task group 2 and task group 3. Task group 1 is consisted by three tasks. Task group 2 is consisted by five tasks. Task group 3 is consisted by five tasks. Actually the present invention does not limit the number of tasks of its supported application and how to group them. There are five threads T1, T2, T3, T4 and T5 in FIG. 4A, as an example, and each of the threads T1, T2 and T3 includes one task group.

The application traffic is originated from a task and then transmitted through the thread layer and node layer. Refer to the section of “Nocsep system layering” for the details of transmission. There are also four nodes N1, N2, N3 and N4 shown in FIG. 4A, and node N3 includes two threads T3 and T4, as an illustrative example.

### PACMDF

The present invention also proposes a “parallel application communication mechanism description format” to describe the task graph of a parallel application, i.e. the application-driven traffic G1 in FIG. 4A. The “parallel application communication mechanism description format” is abbreviated as PACMDF, and they are used interchangeably in the specification and claims.

The PACMDF is a text format applying to a parallel application to describe the patterns of communication amount and computation amount. The patterns of the parallel application are described with the format of PACMDF, which is easy to write and modify. A NoC design has a strong dependency on the applications executed by the system. Therefore, in addition to hardware models, corresponding software models of the applications are also required in order to run an integrated simulation of the software and hardware.

The PACMDF uses a row of text to describe a task. The PACMDF simplifies the complicated information brought by the graphs and uses text to generate the input codes of an application. The PACMDF divides the task graph of an application into eight groups summarized in Table 2.

(Continued)

TABLE 2

| Category | Sub-category | Content |
|---|---|---|
| computation | computation task | Describe how to use the |
| task | | computing units, including |
| | | the computation works of |
| | | this application. |
| communication | data sending task | Describe how much data |
| task | | will be sent and |
| | | when/where it will be sent |
| | | out. |
| | notification sending | Describe how much |
| | task | non-data messages will be |
| | | sent and when/where it |
| | | will be sent out. |
| | | (Non-data messages refer |
| | | to an ACK packet, a |
| | | control packet, etc.) |
| | memory read | Describe when and how to |
| | | read data from an address |
| | | of a memory, including the |
| | | address and the data size |
| | memory write | Describe when and how to |
| | | write data to an address of |
| | | a memory, including the |
| | | address and the data size |
| task graph | thread re-run | Describe the application |
| control | | evaluation mechanism |
| | | which is not shown in |
| | | application graph. It |
| | | comprises limited re-runs |
| | | (numbers or conditions for |
| | | re-runs), unlimited re-runs, |
| | | and limited re-runs which |
| | | terminate the entire |
| | | application. |
| | supplemental | Describe the fields for |
| | information | supplemental information. |
| | thread forced to idle | Describe when and how to |
| | for a while | interrupt one Thread for a |
| | | while releasing the Node |
| | | resources. |

The PACMDF comprises many fields corresponding to the task categories in Table 2. PACMDF uses these fields to contain the required information mentioned above for each task sub-category. The fields of PACMDF are summarized in Table 3.

TABLE 3

| | PACMDF | | |
|---|---|---|---|
| Attribute | Field | Meaning | Example |
| Executed | Mark | note or | ‘#’ represents “note” |
| or | | execution | ‘;’ represents |
| not | | | “execution” |
| Task type | Type | task type | ‘busy’: computation or |
| | | | I/O access |
| | | | ‘send’: Sending |
| | | | messages, comprising |
| | | | data, instructions, NoC |
| | | | control signals, NoC |
| | | | status-checking |
| | | | requests, etc. |
| | | | ‘ctrl’: |
| | | | evaluation-control |
| Task source | Source | Task source | address ID which |
| address | address | address ID | represents what task |
| | ID | | generates this request. |
| Task | Destination | Task | address ID which |
| destination | address ID | destination | represents what task |
| address | | address ID | receives the data of |
| | | | this request, such |
| | | | as the receiver |
| | | | of the |
| | | | data-sending. |
| Task | Size/ | size/ | the computation amount |
| feature | Execution | execution | of a computation task, |
| | | time | or data-amount sent by |
| | | | a communication task, |
| | | | or the supplement type |
| | | | of the supplemental |
| | | | task |
| Identity | Task ID | identity | The ID of this task |
| Trigger | Triggering | From which | A number |
| features | source | address ID this | |
| | address ID | task must wait | |
| | | for the | |
| | | triggering | |
| | | before the task | |
| | | executes. | |
| | Triggering | From which | A number |
| | source task | task this task | |
| | ID | must wait for | |
| | | the triggering | |
| | | before the task | |
| | | executes. | |
| Execution | Effective | It describes | “p###”: absolute |
| condition | | effectiveness of | probability of the |
| and | | a task, such as | execution |
| Execution | | probability of | “initial”: executes only |
| feature | | executing a task | one time as the |
| | | or conditions of | application starts |
| | | executing | “forever”: re-run it over |
| | | control | again |
| | | | “b####”: dependent |
| | | | probability of the |
| | | | execution. The |
| | | | probability is dependent |
| | | | on if the last one task |
| | | | has ever executed. |
| Task | Priority | The priority of | A number. |
| priority | | this task | |

Table 3 lists only the essential fields of the PACMDF, and it can be expanded to have more fields according to the needs in practice. Table 3 is only an example of the PACMDF fields, but it is not used to restrict the application of the PACMDF.

To explain what PACMDF describes more clearly, we give an example of a task-graph application and its PACMDF description in the following. The PACMDF is not restricted to describe the given application example. Refer to FIG. 4B, it shows a parallel pipeline application in a task graph. Eight blocks respectively represent eight computation tasks, comprising computation tasks 41-48. Each of the computation blocks contains an operation type and an operation value. For example, IntAddOp=1000 means that 1000 times of integer addition operation are to be performed. PACMDF can describe other kinds of computation types such as floating addition, integer multiplying, etc. In FIG. 4B, each of the arrow segments represents a communication task, and the accompanying number with the arrow segment represents the size of the data (in bytes) to be transmitted. For example, 64 B represents 64 bytes. All tasks are grouped with the group ID the same as the leading computation tasks. For example, the computation task 41 and all the three communication tasks after it are grouped with the “task group ID” TG41. The computation task 41 is triggered by itself. The computation task 48 is triggered by any of its preceding communication tasks, one of the communication tasks from computation tasks 45, 46 or 47. Once the computation task 48 has been executed 1000 times, the parallel pipeline application in FIG. 4B terminates.

Table 4 shows the PACMDF expression of FIG. 4B. The first field in Table 4 is inserted to show the corresponding row number of each row. However, it can be omitted in practice. Each row in Table 4 represents a task. Type “busy” means a computation task, Type “send” means a communication task, and Type “ctrl” means an evaluation-control task. Table 4 is shown in a landscape orientation.

(Continued)

TABLE 4

| | | | | | Size/ | | | | | |
|---|---|---|---|---|---|---|---|---|---|---|
| | | | Source | Destination | Execution | | Triggering | Triggering | | |
| Row # | Mark | Type | address ID | address ID | Time | Task ID | address ID | task ID | Effective | Priority |
| 1 | # | Task | | | | | | | | |
| | | Group | | | | | | | | |
| | | TG41 | | | | | | | | |
| 2 | ; | busy | 41 | | 1 | 1 | | | Initial | 1 |
| 3 | ; | busy | 41 | | inp1000 | 1 | | | Initial | 1 |
| 4 | ; | send | 41 | 42 | 64 | S2 | | | p1 | 1 |
| 5 | ; | send | 41 | 43 | 64 | S2 | | | p1 | 1 |
| 6 | ; | send | 41 | 44 | 64 | S2 | | | p1 | 1 |
| 7 | ; | busy | 41 | | inp1000 | 1 | | | p1 | 1 |
| 8 | ; | ctrl | 41 | | end | 3 | | | 1000 | 1 |
| 9 | # | Task | | | | 4 | | | | |
| | | Group | | | | | | | | |
| | | TG42 | | | | | | | | |
| 10 | ; | busy | 42 | | 1 | 1 | | | Initial | 1 |
| 11 | ; | busy | 42 | | inp1000 | 5 | | | Initial | 1 |
| 12 | ; | send | 42 | 45 | 64 | S6 | | | p1 | 1 |
| 13 | ; | busy | 42 | | inp1000 | 5 | | 2 | p1 | 1 |
| 14 | ; | ctrl | 42 | | end | 7 | | | 1000 | 1 |
| 15 | # | Task | | | | 8 | | | | |
| | | Group | | | | | | | | |
| | | TG43 | | | | | | | | |
| 16 | ; | busy | 43 | | 1 | 1 | | | Initial | 1 |
| 17 | ; | busy | 43 | | inp1000 | 9 | | | Initial | 1 |
| 18 | ; | send | 43 | 46 | 64 | S10 | | | p1 | 1 |
| 19 | ; | busy | 43 | | inp1000 | 9 | | 2 | p1 | 1 |
| 20 | ; | ctrl | 43 | | End | 11 | | | 1000 | 1 |
| 21 | # | Task | | | | 12 | | | | |
| | | Group | | | | | | | | |
| | | TG44 | | | | | | | | |
| 22 | ; | busy | 44 | | 1 | 1 | | | Initial | 1 |
| 23 | ; | busy | 44 | | inp1000 | 13 | | | Initial | 1 |
| 24 | ; | send | 44 | 47 | 64 | S14 | | | p1 | 1 |
| 25 | ; | busy | 44 | | inp1000 | 13 | | 2 | p1 | 1 |
| 26 | ; | ctrl | 44 | | End | 15 | | | 1000 | 1 |
| 27 | # | Task | | | | 16 | | | | |
| | | Group | | | | | | | | |
| | | TG45 | | | | | | | | |
| 28 | ; | busy | 45 | | 1 | 1 | | | Initial | 1 |
| 29 | ; | busy | 45 | | inp1000 | 16 | | | Initial | 1 |
| 30 | ; | send | 45 | 48 | 64 | S18 | | | p1 | 1 |
| 31 | ; | busy | 45 | | inp1000 | 16 | | 6 | p1 | 1 |
| 32 | ; | ctrl | 45 | | End | 19 | | | 1000 | 1 |
| 33 | # | Task | | | | 20 | | | | |
| | | Group | | | | | | | | |
| | | TG46 | | | | | | | | |
| 34 | ; | busy | 46 | | 1 | 1 | | | Initial | 1 |
| 35 | ; | busy | 46 | | inp1000 | 21 | | | Initial | 1 |
| 36 | ; | send | 46 | 48 | 64 | S22 | | | p1 | 1 |
| 37 | ; | busy | 46 | | inp1000 | 21 | | 10 | p1 | 1 |
| 38 | ; | ctrl | 46 | | End | 23 | | | 1000 | 1 |
| 39 | # | Task | | | | 24 | | | | |
| | | Group | | | | | | | | |
| | | TG47 | | | | | | | | |
| 40 | ; | busy | 47 | | 1 | 1 | | | initial | 1 |
| 41 | ; | busy | 47 | | inp1000 | 25 | | | initial | 1 |
| 42 | ; | send | 47 | 48 | 64 | S26 | | | p1 | 1 |
| 43 | ; | busy | 47 | | inp1000 | 25 | | 14 | p1 | 1 |
| 44 | ; | ctrl | 47 | | End | 27 | | | 1000 | 1 |
| 45 | # | Task | | | | 28 | | | | |
| | | Group | | | | | | | | |
| | | TG48 | | | | | | | | |
| 46 | ; | busy | 48 | | 1 | 1 | | | initial | 1 |
| 47 | ; | busy | 48 | | inp1000 | 29 | | | initial | 1 |
| 48 | ; | busy | 48 | | inp1000 | 29 | | complex | p1 | 1 |
| 49 | ; | para | 48 | | w_or | 29 | 13 | 18 | | 1 |
| 50 | ; | para | 48 | | w_or | 29 | 14 | 22 | | 1 |
| 51 | ; | para | 48 | | w_or | 29 | 15 | 26 | | 1 |
| 52 | ; | ctrl | 48 | | End | 31 | | | 3000 | 1 |
| 53 | # | Task | | | | 32 | | | | |
| | | Group | | | | | | | | |
| | | TG49 | | | | | | | | |
| 54 | ; | ctrl | 49 | | End | 35 | | | 1 | 1 |
| 55 | # | END OF | | | | 36 | | | | |
| | | Trace | | | | | | | | |
| | | File | | | | | | | | |

In Table 4, the empty field represents “don't care value”. Each line represents a task with a specified task ID, which can be assigned with the same number to different tasks when no confusion will occur. There is another ID number assigned to some tasks, such as the ID number from 41 to 48. These IDs are called “address ID” and each of them will be mapped to one real computation nodes or hardware unit of the NoC system. When the “source” of one task is assigned with one address ID, it implies that we distribute that task to the real computation node or hardware unit of the NoC system with that address ID.

The computation task group TG41 is divided into eight tasks respectively corresponding to Row numbers 1-8. Row 1 starts with # in “Mark” which means a comment exempted from execution. Row 2 is an initiation of a computation task because the field “Effectiveness” is “initial”. Row 3 executes the operation IntAddOp1000 shown inside the computation block—the operation of integer addition 1000. After the operation is finished, Row 4 sends data of 64 bytes to the destination block 42. In the “Task ID” field of Row 4 is “S2”, “S” of “S2” means that Row 4 will trigger at least a task in another row. In Table 4, Rows 13, 19 and 25 have a value 2 in the field of “Triggering task ID”, and it means that Rows 13, 19 and 25 will not start until the data of the task of Row 4 is arrived. The “Effective” field of Row 4 has a value of “p1”; it means that the execution of Row 4 has an “absolute probability of 1”.

In Row 52, the field of “Effective” has a value of 3000, which means that the row will be executed repeatedly 3000 times. The field of “Size/Execution time” of Rows 49-51 represents which supplement type the tasks (i.e. Row 49-51) are belonged to. Rows 49-53 provide the supplemental information for the task before them which has a field marked with “complex” (i.e. Row 48). In Rows 49-51, “w_or” means that the message of Row 48 from any of these three “triggering address ID and triggering task ID” can trigger the task (Row 48). Rows 49-51 also indicate that the computation task of the block 48 in FIG. 4B will not be triggered until one of the computation tasks of the blocks 45, 46 and 47 is completed. In Row 48, “complex” appears in the field of “Triggering task ID”, which means that the row is waiting for the start of a special condition instantly following it. For example, Row 48 is waiting for the “w_or” operations in Rows 49-51. The field “priority” is used to describe the priority of this task.

Thus, the PACMDF can use the text in Table 4 to express the task graph in FIG. 4B, and Table 4 can illustrate FIG. 4B in details.

### Middle Layer Modeling

The present invention provides fine modeling for the middle layers. Herein, the middle layers refer to the layers between a NoC and an application layer, comprising a node modeling and an adaptor modeling.

A node combines the processing element structure and the OS (Operating System) process handling. The node layer stresses only the behaviors that can significantly influence the traffic and reduce other unnecessary details in the processing element and the OS.

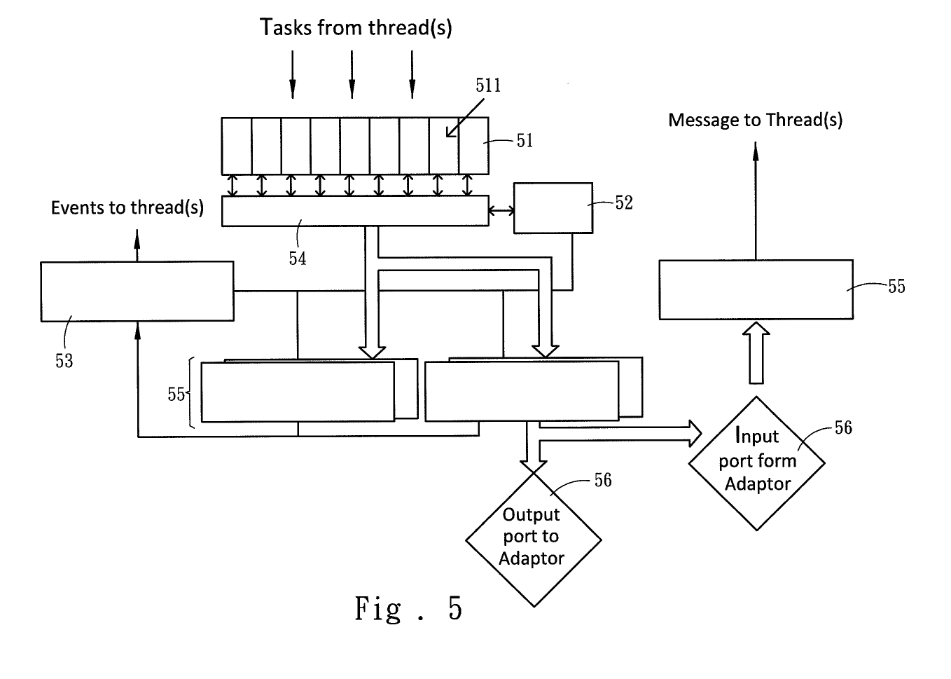

FIG. 5 shows a node modeling, the tasks from the threads enter the request table 51 which is a list holding all entering tasks temporarily. The request table 51 contains a plurality of slots 511. Each of the slots 511 is assigned to a specified thread ID and a specified task priority. There are three core units 55 shown in FIG. 5, comprising a computation core and two communication cores. A kernel manager 52 is a software unit responsible for arbitration. The kernel manager 52 selects a task from the request table 51 and distributes it to one of the core units 55 through a task arranger 54. The assigned core unit 55 then processes all the services the task describes. If the assigned core unit 55 is a computation unit, it may delay to deal with the assigned computation task for a while according to the preset computation capability thereof. When a NoC executes two or more threads, there are data transmissions between the threads involved. Accordingly, the source thread of the message will send the requested data to the destination thread via the output ports 56 and by the assigned core unit 55. If the assigned core unit 55 is a communication unit, it generates the data of the task and sends the data to an adaptor via the output ports. The output ports will communicate with the adaptor, and the adaptor will transform the data into the NoC traffic format. There is also an event collector and task-trigger unit 53, which sends the events which happens in the Node to the corresponding threads to make the task-triggering in the task graph correctly.

Herein, it should be particularly mentioned that a task is unlikely to be processed unless the kernel manager 52 selects it. The node modeling of the present invention has the appropriate flexibility. That is, the numbers of the kernel managers, computation cores and communication cores in FIG. 5 can all be parameterized. It should be noted that FIG. 5 is only an example of the present invention, not a restriction.

In the node modeling shown in FIG. 5, the traffic distortion may come from:
1. If the slot 511 is occupied, it cannot provide Service for the Task.
2. If the numbers of the kernel managers 52 or the core units 55 are insufficient, the messages generated by the executed task will be blocked.
3. The time-sharing mechanism of the core units 55 influences the traffic.

The adaptors are used to separate the traffic of a NoC and nodes. Because of the adaptor layer, various NoC designs can be compared under the same simulation conditions.

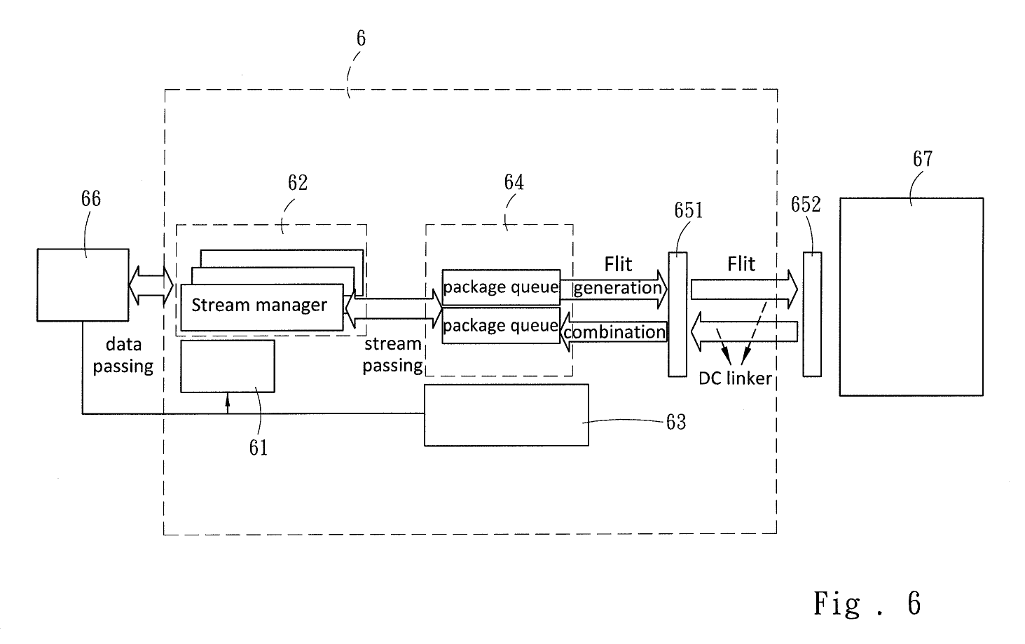

FIG. 6 shows the modeling of an adaptor 6. A manager allocator 61 and a buffer resource allocator 63 are respectively used to allocate a manager resource 62 and a buffer resource 64 for the communication cores (as shown in FIG. 5) of a node 66. The allocation decides whether a stream can be smoothly sent out or keeps waiting for resources. The manager resource 62 comprises a plurality of stream managers. The buffer resource 64 comprises a plurality of package queues. When a stream manager is allocated and begins to be transmitted, the communication cores of the node 66 sends the data to the package queue of the buffer resource. In the package queue, the data is transformed into a NoC transfer package. The NoC transfer package is a data structure that a NoC can transfer. The package-switched network or the flit-based direct-linked network uses a packet or a flit (flow control unit) as the transfer package. The circuit-switched NoC or another direct-linked network uses a transaction unit as the transfer package.

The adaptor 6 comprises a port 651. The adaptor 6 encapsulates transfer packages, sends the transfer packages from the port 651 of the adaptor to the port 652 of the NoC and maintains the end-to-end flow control. If the port 652 of the NoC is busy or the package queues are fully occupied, the stream manager 62 has to wait. If the application is very sensitive to latency or the space of the buffers is very limited, the design of adaptor 6 has great influence on performance and traffic throughput.

In the adaptor layer, the package generation rate, the maximum queue length, the handling latency of each procedure and the total buffer resources are all parameterized.

In the present invention, the NoC design space is definitely partitioned. The system is divided into several layers, and each of the layers is divided into several components. A plurality of latency parameters is used to implement a NoC simulation.

The NoC design of the present invention is not restricted by the layering of FIG. 3. It is unnecessarily limited to the model, shown as FIG. 3, with a task layer, a thread layer, a node layer, an adaptor layer, etc. The present invention of Nocsep can support various NoC designs.

The embodiments described above are only to demonstrate the spirit and characteristics of the present invention but not to limit the scope of the present invention. The scope of the present invention is based on the claims stated below. However, it should be interpreted from the broadest view, and any equivalent modification or variation according to the spirit of the present invention should be also covered within the scope of the present invention.

What is claimed is:

1. A network-on-chip-centric system exploration platform comprising:
a model design used to model a network-on-chip (NoC)-centric system, comprising a software model, a hardware model and a communication message model, wherein said communication message model describes a plurality of Services of a network-on-chip, and said hardware model and said software model describe methods for generating and handling said Services;
a system framework design, which partitions said network-on-chip into a plurality of layers and defines function behaviors and message transmission methods of each of said layers to establish a traffic pattern from the topmost level to the bottommost level in all said layers; and
a simulator, which provides a method for evaluating performance independent from said model design and said system framework design.

2. The network-on-chip-centric system exploration platform according to claim 1, wherein said system framework design partitions said network-on-chip into said layers and models said layers, and said layers comprise:
(a) a task layer inputting an application containing a plurality of tasks and describing features of said application;
(b) a thread layer comprising a plurality of thread modules, and each of said threads containing at least one said task;
(c) a node layer comprising a plurality of node modules, said task entering said node layer and being transformed into at least one message, wherein each of said node modules further comprising:
(1) a request table temporarily holding all said messages entering said node layer,
(2) a plurality of core units further comprising at least one computation core and at least one communication core,
(3) at least one kernel manager responsible for arbitration, selecting said task from said request table, and sending said message of said task to one of said core units for processing, and
(4) at least one port functioning as an output of said node layer;
(d) an adaptor layer comprising a plurality of adaptor modules, said message sending to said adaptor layer and being transformed into at least one stream and each said stream into at least one said package, wherein each said adaptor module further comprising:
(1) at least one manager allocator allocating a stream manager resource, and
(2) at least one buffer resource allocator allocating a buffer resource, wherein said manager resource and said buffer resource determines whether said stream is sent out or keeps waiting for the resources;
(e) an on-chip-communication-architecture (OCCA) layer, and said stream sending to said OCCA layer and being transformed into a traffic format of a transfer package.

3. The network-on-chip-centric system exploration platform according to claim 2, wherein a latency time is added to each of said tasks and a cycle-approximate latency modeling is used to evaluate the performance of said network-on-chip.

4. A parallel application communication mechanism description format, which uses a text to describe a task graph of a parallel application input into a network-on-chip-centric system and develops said task graph into a text format comprising a plurality of fields and a plurality of rows, wherein each of said rows represents a task, and wherein said fields comprise:
a task type field used to describe said task as a computation task, a communication task or a control task;
a task source address ID field used to describe a source address ID of said task;
a destination address ID field used to describe a destination address ID if said task is a communication task;
a task feature field used to describe an operation numeral if said task is a computation task, or bytes transferred in said communication task;
a trigger feature field used to describe a condition to trigger said task;
a priority field used to describe the priority of this task; and
an execution condition and execution feature field used to describe execution numbers of said task, execution probability or conditions of said task.
